(19) United States
(12) Patent Application Publication
(10) Pub. No.: US 2017/0024699 A1
(43) Pub. Date: Jan. 26, 2017

(54) ONLINE MATCHMAKING METHOD AND SYSTEM

(71) Applicant: FACE TO FACE TECHNOLOGIES INC., Toronto (CA)

(72) Inventors: James MILLERSHIP, Toronto (CA); Sean MILLER, Toronto (CA); Adam THODY, Toronto (CA)

(21) Appl. No.: 15/300,843

(22) PCT Filed: Mar. 31, 2015
(86) PCT No.: PCT/CA2015/050248

§ 371 Date: Sep. 30, 2016

Related U.S. Application Data
(60) Provisional application No. 61/972,929, filed on Mar. 31, 2014.

(51) Int. Cl. G06Q 10/10; G06Q 20/26; H04L 12/18; H04L 29/06

(52) U.S. Cl. CPC G06Q 10/109; H04L 67/42; G06Q 10/105; G06Q 20/26; H04L 12/1818; H04L 12/1831

(57) ABSTRACT

The present disclosure relates to an online matchmaking system and method. A plurality of participants, each having a profile, is invited to an online matchmaking event. For each participant, a predetermined number of complementary participant profiles are determined. Online meetings are set up, each online meeting being held between participants having complementary profiles. Each participant attends a number of online meetings corresponding to the predetermined number. For each given online meeting, a feedback is received from a participant to the given online meeting, the feedback being related to an other participant to the given online meeting. Determination is made whether there is a two-way match between participants to a given online meeting based on feedback received from at least one of the participants to the given online meeting. Each participant is informed of a number of two-way matches determined from the online meetings the participant has attended.

### TECHNICAL FIELD

The present disclosure relates to the field of client server based services. More specifically, the present disclosure relates to a method of setting up online matchmaking meetings between participants and to an online matchmaking system.

### BACKGROUND

Finding the right person can be a frustrating experience, whether one is looking for an ideal date for having a romantic relationship, a suitable employee for filling a job position, or finding a business partner sharing complementary interests and qualifications.

These problems have traditionally been addressed with limited reliance on technology. For the longest time, people have counted on their interpersonal skills, on their contact networks, and on life opportunities to fill these needs. Professional services such as recruiting services (headhunters), dating agencies, and the like, traditionally used personal skills to perform matchmaking or to organize speed dating sessions.

Attending an offline speed dating session may require expensive upfront payment, travelling to the session's location, living through stress, discomfort and fear of possible rejection, all without any guarantee of finding a suitable match.

Sifting through piles of resumes in the hope of identifying a suitable candidate for a job position is a tedious task for human resource personnel and for line managers, who may waste time interviewing several candidates who end up not meeting the employment requirements and while at the same time not knowing that they may be overlooking the best available candidates. Scanning through multiple web sites in the hope of finding a suitable business partner is also tedious and innefective.

More recently, matchmaking services have been offered on the Internet. Most of these are dating services and cater to responding to their members' need to find soul mates. A dating site will provide a subscriber with a match, i.e. the identity of another subscriber with whom a real-life meeting can be arranged. This type of meeting may be stressful for some persons, stress sometimes causing the meeting to fail, even when two people have been properly matched. Subscribers need to return to the dating site and be provided with a match to yet another subscriber, for another stressful meeting. In a worst case, the subscriber can be matched with an ill-intended participant to a dating site, possibly leading to a disastrous encounter and even to legal consequences to the operator of the dating site. Even in a better case, properly matched subscribers are left on their own and do not benefit from any support from the dating site for helping them build their relationship.

Therefore, there is a need for matchmaking systems and methods that provide better matches, provide more services and, overall, offer a better experience to their users.

### SUMMARY

According to the present disclosure, there is provided an online matchmaking method. A plurality of participants, each of which has a participant profile, is invited to an online matchmaking event. For each participant, a predetermined number of complementary participant profiles is determined. Online meetings are set up within the online matchmaking event, each online meeting being held between participants having complementary profiles. Each participant is offered to attend a number of online meetings corresponding to the predetermined number of complementary profiles. For each given online meeting, a feedback is received from a participant to the given online meeting, the feedback being related to an other participant to the given online meeting. For each given online meeting, determination is made whether there is a two-way match between participants to the given online meeting based on feedback received from at least one of participants to the given online meeting. Each participant is informed of a number of two-way matches determined from the online meetings the participant has attended in the course of the online matchmaking event.

According to the present disclosure, there is also provided an online matchmaking system. The system comprises a database and a matchmaking server. The database stores a participant profile for each of a plurality of participants to an online matchmaking event. The matchmaking server has a communication interface able to establish connections with communicating client devices of each of the plurality of participants. The matchmaking server is operably connected to the database. The matchmaking server also comprises a processor, which is configured to invite the plurality of participants to the online matchmaking event, determine, for each participant, a predetermined number of complementary participant profiles, set up online meetings within the online matchmaking event, each online meeting being held between participants having complementary profiles, each participant being offered to attend a number of online meetings corresponding to the predetermined number of complementary profiles, for each given online meeting, receive from a participant to the given online meeting a feedback related to an other participant to the given online meeting, for each given online meeting, determine whether there is a two-way match between participants to the given online meeting based on feedback received from at least one of the participants to the given online meeting, and inform each participant of a number of two-way matches determined from the online meetings the participant has attended in the course of the online matchmaking event.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a sequence diagram showing operations of an online matchmaking method according to a first embodiment;

FIGS. 2a and 2b collectively are a sequence diagram showing operations for providing a participant with added services according to the first embodiment;

FIG. 3 is a block diagram of an example online matchmaking system;

FIG. 4 is a sequence diagram showing operations of an online matchmaking method according to a second embodiment;

FIG. 5 is a sequence diagram showing operations of a method of registering a participant to the online matchmaking system of FIG. 3;

FIG. 6 is a sequence diagram showing operations that precede an online matchmaking event;

FIG. 7 is a sequence diagram showing various operation scenarios occurring in the course of the online matchmaking event;

FIGS. 8a and 8b collectively are a sequence diagram showing various operation scenarios occurring after the conclusion of the online matchmaking event; and

FIGS. 9 to 13 are screen captures of displays viewable on communicating client devices of participants to the online matchmaking event.

### DETAILED DESCRIPTION

Various aspects of the present disclosure generally address one or more of the problems of traditional matchmaking and of earlier online dating sites.

The following terminology is used throughout the present disclosure:
Matchmaking: activity related to enabling two or more persons to meet and establish a relation.
Dating: a type of matchmaking intended for establishing a romantic relation.
Online meeting: a meeting held by two or more participants using individual communicating client devices and connected via a server.
Online matchmaking event: a session in which a number of distinct online meetings are held, a plurality of online meetings being held concurrently, a plurality of online meetings for a given participant being successively held.
Two-way match: a finding that two of the participants to an online meeting provided favorable feedback for each other. When more than two participants attended a same online meeting, a two-way match may include two or more of the participants, based on feedback they provided. Alternatively, when more than two participants attended a same online meeting, distinct two-way matches may be determined for any pair of these participants.
One-way match: a finding that one of the participants to an online meeting provided favorable feedback for another participant to the online meeting.
Visitor: somebody potential user who comes to the site without providing information, at least initially.
Lead: somebody who comes to the site and provides email, postal/zip code, and selects a category.
Free Trial (cc): somebody who registers for a get together and provides their credit card to hold their spot.
Participant: somebody who has registered for a get together and actually participates in the get together, without cancelling or failing to appear (“no show”).
Paying User: somebody who participates in a get together and purchases a product a la carte or subscribes.

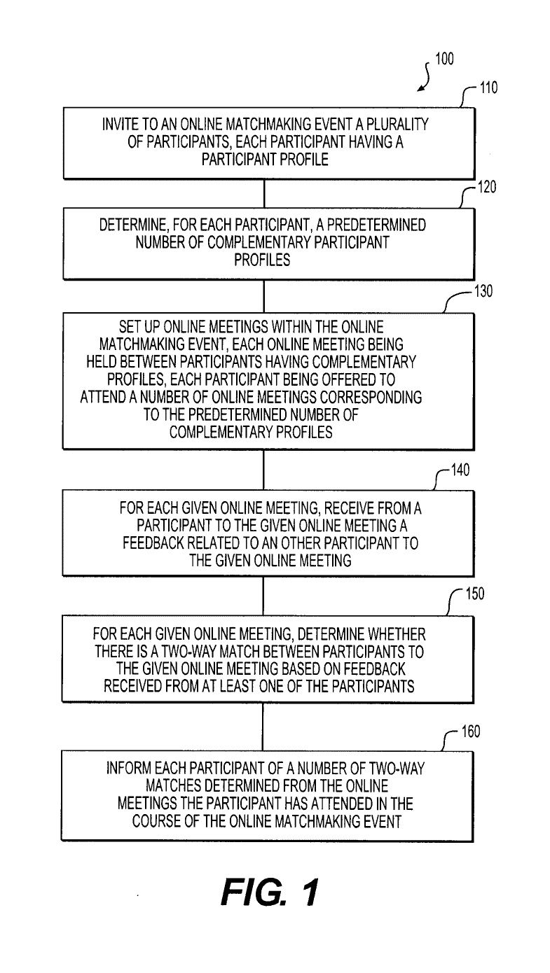

Referring now to the drawings, FIG. 1 is a sequence diagram showing operations of an online matchmaking method according to a first embodiment. In FIG. 1, a sequence 100 comprises a plurality of operations that may be executed in variable order, some of the operations possibly being executed concurrently, some of the operations being optional. At operation 110, a plurality of participants to an online matchmaking service, each of whom has a participant profile, are invited to an online matchmaking event. A predetermined number of complementary participant profiles are determined, for each participant, at operation 120. Online meetings are set up within the online matchmaking event, at operation 130. Each online meeting is held between participants having complementary profiles. For some types of matchmaking activities, online meetings are expected to be held between a pair of participants. For other types of matchmaking activities, two or more participants may attend a same online meeting. Since the predetermined number of complementary participant profiles has been determined for each participant, each participant is offered to attend a number of online meetings corresponding to that predetermined number of complementary profiles. Each online meeting may have a predetermined duration. Each online meeting may involve setting up of an audio connection, or a video connection, or an audio/video connection. At operation 140, for each given online meeting, a feedback is received from one or both of the participants to the given online meeting, the feedback received from one participant being related to an other participant to the given online meeting. Feedback may be received while an online meeting is ongoing, after termination of each online meeting, or at the end of the online matchmaking session. Some participants may neglect to provide feedback for an online meeting. Optionally, predetermined feedback status, either positive or negative, may be deemed having been received when a given participant fails to provide a feedback for an online meeting in which the given participant has attended.

Two-way match determination is made at operation 150. For each given online meeting, a two-way match between participants to the given online meeting is determined based on feedback received from at least one of the participants. At operation 160, each participant is informed of a number of two-way matches determined from the online meetings the participant has attended in the course of the online matchmaking event.

In a first variant of operation 120, the complementary participant profiles for a given participant may be determined before a first online meeting for the given participant. In a second variant of operation 120, a first complementary participant profile for a given participant may be determined before a first online meeting for the given participant. Determination of a next complementary participant profile for the given participant may then be made before a next online meeting for the given participant. As an additional operation within operation 120, identification may be made of participants having left the online matchmaking event before determining next complementary participant profiles for remaining participants.

In the determination of complementary profiles, the complementary participant profiles for a given participant may include best, or ideally matched complementary participant profiles. However, some participants may have provided for themselves profile information that is not easily matched with other profiles. Searching solely for ideal complementarity between participant profiles may render difficult scheduling the predetermined number of complementary participant profiles for some participants. Therefore, the predetermined number of complementary participant profiles may optionally comprise a selection of at least one non-optimal complementary participant profile for a given participant. These variants and others may be made part of a matching algorithm for scheduling the predetermined number of complementary participant profiles for some participants.

Depending on the type of matchmaking service offered, the profile information of each participant may include various content types. For example, the profile information may comprise information about business interests of each participant, for use when the online matchmaking event is intended to support development of business relations. In another example, the profile information may comprise information about personal interests of each participant, for use when the online matchmaking event is intended to lead to developing personal relations. As an illustration, participants seeking employment candidates, participants desiring to find teammates for a hockey team, or participants desiring to find musicians for forming a band, may use the matchmaking service.

Without limiting the present disclosure, the online matchmaking service may be used as a form of dating service and the online matchmaking event may be an online dating event. In such a case, the participant profile may comprise profile information of a personal nature. As non-limiting examples, the profile information for each participant may comprise one or more of a nickname, an age, an age range for complementary profile determination, a gender, a sexual orientation, a location of residence, a range of distance from location of residence for complementary profile determination, a participant body type, a participant personality type, a participant eye color, a participant hair color, a participant's physical preferences for complementary profile determination, a participant's interests. Any combination of the above profile parameters and other of further profile parameters of a similar nature are within the scope of the present disclosure.

Returning to operations 140 and 150, these operations involve receiving and using feedback provided by participants, the feedback being in regard of other participants of online meetings. In a variant of these operations, the feedback related to an other participant may either be favorable or unfavorable, the participants providing a simple ‘Yes’ or ‘No’ answer, a ‘thumbs up’ or a ‘thumbs down’ indication, or any other suitable binary indication. In such a variant, a two-way match is obtained when two of the participants to a given online meeting both provide favorable feedbacks for each other. In another variant of operations 140 and 150, the feedback related to an other participant may be provided on a graded scale. In that variant, a two-way match may be determined when two of the participants to a given online meeting both provide at least a minimum score on the graded scale. Alternatively, a two-way match may be determined irrespective of a minimum score so that each participant will be presented with at least a minimum number of two-way matches calculated according to best available feedback situations for the online matchmaking session.

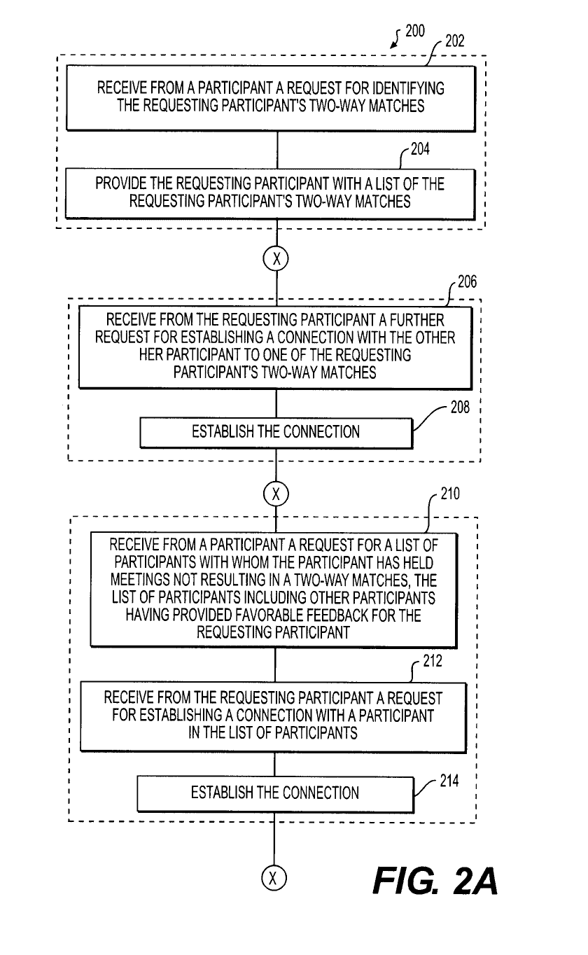

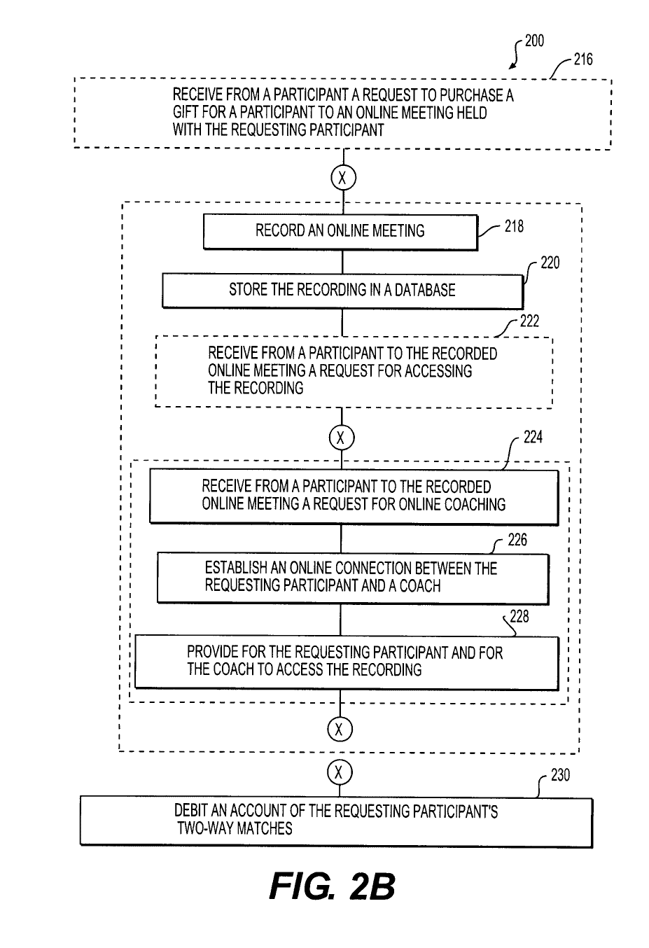

Value-added services may be made available to participants to the online matchmaking session. Generally, these added services can be offered to paying participants. Each participant has an account that may be filled by the participant providing a credit card number or by similar purchasing methods. FIGS. 2a and 2b collectively are a sequence diagram showing operations for providing a participant with added services according to the first embodiment. In FIGS. 2a and 2b, a sequence 200 comprises a plurality of operations that may be executed in variable order, some of the operations possibly being executed concurrently, some of the operations being optional. Operation 202 includes receiving from a participant a request for identifying the requesting participant's two-way matches. Provision is made to the requesting participant, at operation 204, of a list of the requesting participant's two-way matches. As indicated by the connector showing a reference ‘X’, the sequence continues at operation 230 where an account of the requesting participant is debited. The sequence 200 may terminate at this point, or may continue with another request for an added service. For example, a further request for establishing a connection with an other participant to one of the requesting participant's two-way matches identified in the list provided at operation 204 may be received from the requesting participant at operation 206. The requested connection is established at operation 208 (with consent of the other participant) and the account of the requesting participant is debited again at operation 230.

Alternatively, the sequence 200 may be initiated with a request for another type of added service. For example, a request for a one-way match list may be received at operation 210. This one-way match list includes identities of participants with whom the participant has held meetings not resulting in two-way matches, the one-way match list including identities of other participants having provided favorable feedback for the requesting participant. The requested list is provided and the account of the requesting participant is debited at operation 230. A further request for establishing a connection with a participant identified in the one-way match list provided at operation 210 may be received from the requesting participant at operation 212. The requested connection may be established at operation 214 (with consent of the other participant) and the account of the requesting participant is debited again at operation 230. As another option, the requesting participant may change his/her feedback in order to establish a two-way match with a participant identified in the one-way match list.

As yet another added service, operation 216 includes receiving from a participant a request to purchase a gift for an other participant to an online meeting held with the requesting participant. This request may be received while the online meeting is ongoing, or some time thereafter. The gift is delivered, or planned for delivery, and the account of the requesting participant is debited at operation 230. In the case of a gift deliverable electronically (MP3 file, electronic book, electronic movie ticket, and the like), delivery may be substantially immediate, as long as the receiver of the gift is reachable electronically at that time. In other cases (flowers, chocolates, and the like), an announcement about the gift is timely provided to the other participant.

Some added services involve providing a participant with access to a recording of an online meeting. The recording may include audio and/or video media. An online meeting is recorded at operation 218, and stored in a database at operation 220. Operations 218 and 220 may be performed for any number of online meetings. Operation 222 comprises receiving from a participant to a recorded online meeting a request for accessing the recording and providing the content to the requesting participant. The account of the requesting participant is debited at operation 230. Alternatively or in addition, operation 224 comprises receiving from a participant to a recorded online meeting a request for online coaching. An online connection is established between the requesting participant and a coach at operation 230. Provision is made at operation 228 for the requesting participant and for the coach to access the recording. The account of the requesting participant is debited at operation 230.

A variant of sequences 100 and 200 may include detecting that a given participant did not provide any feedback in the course of the online matchmaking event, or within a predetermined time period thereafter. If the given participant does not select an opting-out feature, the account of the given participant is debited.

Any one of the operations 110 to 160 and 202 to 230 may be executed by one or more processors, the one or more processors being for example implemented in a server, the one or more processors being coupled to a memory, the memory being for example implemented as a database. The server may be a matchmaking server in communication with communicating client devices of each participant. The matchmaking server determines, for each participant, the predetermined number of complementary participant profiles. The matchmaking server may further be in communication with one or more cooperating servers. In that case, one or more of the participants to the online matchmaking event may be subscribers to the cooperating servers, which provide profile information for their subscribers to the matchmaking server for storage in a database of the matchmaking server.

The following events relate to operational preparation for holding an online matchmaking event. A subscriber list is stored in a matchmaking server, along with a profile for each subscriber. Planning information about the online matchmaking event is presented so that it is available to each subscriber. The planning information may be sent by email, short message (SMS), Tweet, and the like, towards each subscriber. Alternatively, a schedule of an upcoming online matchmaking event may be broadcasted towards all subscribers, or to the general public, for example by displaying the schedule on a web page to invite anyone interested in participating in the event (a new user from the general public would need to first subscribe to the matchmaking service and provide profile information before registering to the online matchmaking event). A plurality of subscriber registrations for the online matchmaking event are received at the matchmaking server. Identities of the subscribers having registered to the online matchmaking event are added to a list of participants.

As expressed hereinabove, accounts are established for obtaining payment from subscribers to the matchmaking service for a variety of services. Without limitation, the present disclosure includes the possibility for a participant to purchase a number of tokens, in exchange for a monetary payment. The tokens may be understood as a form of virtual currency. The tokens are placed in the account for the participant. When the participant makes a request for an added service, a number of tokens are debited from the participant's account. Table 1 shows an example of a pricing schedule for purchasing tokens, also showing number of tokens debited for each added service, and further showing a number of tokens that may be credited to a participant who executes some actions.

TABLE 1
Pricing Table

| | |
|---|---|
| 100 tokens | $20 |
| 250 tokens | $45 |
| 500 tokens | $75 |
| 1000 tokens | $100 |

Number of debited tokens per service

| | |
|---|---|
| Having a session with another party | 100 |
| Revealing two-way matches | 50 |
| Modifying a feedback | 25 |
| Viewing a recording of a meeting | 75 |
| Obtaining coaching | 50 |
| Purchase of lecture series | 100 |

Number of credited tokens per other action

| | |
|---|---|
| Tweet about the service | 5 |
| Facebook Like for the service | 10 |
| Invite a Friend | 10 |
| Provide feedback to the system | 20 |

Considering Table 1, discounts may be provided when a participant purchases a large number of tokens at one time. Various added services are purchased by debiting a number of tokens as defined in the pricing schedule. Optionally, additional tokens may be credited to a participant's account when the participant advertises the online matchmaking service on a social network. The amounts shown in Table 1, in currency or in tokens, are provided for illustration purposes and do not limit the present disclosure.

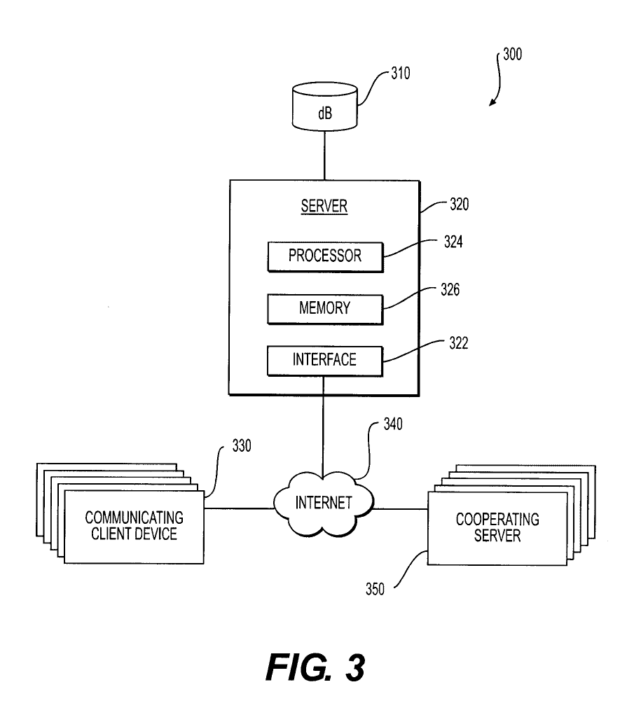

FIG. 3 is a block diagram of an example online matchmaking system. The online matchmaking system 300 comprises a database 310 and a matchmaking server 320. Though illustrated as distinct elements, the database 310 and the matchmaking server 320 may be integrated into a single physical node. The database 310 stores a participant profile for each of a plurality of participants to an online matchmaking event. The matchmaking server 320 has a communication interface 322 adapted to establish connections with communicating client devices 330 of each of the plurality of participants. The matchmaking server 320 may for example be a web server and the communication interface 322 may connect with the communicating client devices 330 via the Internet 340. The matchmaking server 320 is operably connected to the database 310. The matchmaking server 320 also comprises a processor 324. The processor 324 is programmed to invite the plurality of participants to the online matchmaking event, determine, for each participant, a predetermined number of complementary participant profiles, set up online meetings within the online matchmaking event, each online meeting being held between participants having complementary profiles, each participant being offered to attend a number of online meetings corresponding to the predetermined number of complementary profiles, for each given online meeting, receive from a participant to the given online meeting a feedback related to an other participant to the given online meeting, for each given online meeting, determine whether there is a two-way match between participants to the given online meeting based on feedback received from at least one of the participants to the given online meeting, and inform each participant of a number of two-way matches determined from the online meetings the participant has attended in the course of the online matchmaking event.

Programming of the processor 324 may reside in a memory 326 in the form of program instructions. The memory 326 may be a non-transient non-transient computer information storage device. In an embodiment, the processor 324 executes these program instructions to schedule an online matchmaking event, receive registrations to the online matchmaking event from a plurality of participants, access the database 310 to obtain profiles for each of the plurality of the participants, process rules for matching subsets of the plurality of participants based on complementary interests within their profiles, initiate and control online meetings between the subsets, register feedback from the plurality of participants, identify matches among the subsets based on the registered feedback, and provide at least one additional value added service for a fee.

In addition to the elements shown, the matchmaking server 320, the database 310 and, generally the online matchmaking system 300 may all include additional components conventionally found in servers such as for example in web servers. FIG. 3 is greatly simplified for ease of illustration.

While the matchmaking server 320 and the database 310 may form a complete online matchmaking system 300, they may also cooperate with other systems, for example with one or more cooperating servers 350 of other service providers, for example cooperating servers 350 of other dating sites. To this end, the communication interface 322 may further be configured to connect with the one or more cooperating servers 350, possibly via the Internet 340, and to receive therefrom at least one of the participant profiles. Though one communication interface 322 is illustrated on FIG. 3, for simplicity purposes, the matchmaking server 320 may include a plurality of communication interfaces 322 sharing connections with the communicating client devices 330 and with the cooperating servers. Provision of the plurality of communication interfaces 322 may enable load-sharing between the plurality of communication interfaces 322 or may provide redundancy in case of failure of one of the communication interfaces 322. Additionally, bandwidth requirements of communication links towards the communicating client devices 330 may differ from bandwidth requirements of other communication links towards the cooperating servers 350. Different types of communication interfaces 322 may be tailored to accommodate those different bandwidth requirements.

In order to ensure that signals received at the communication interface 322 are from legitimate users, the database 310 may store a user identity and a password for each participant. Then, the processor 324 may verify the user identity and the password of a given participant when the communication interface 322 receives an access to the online matchmaking system 300 from a communicating client device of the given participant. The processor 324 may further verify that a request received from a particular communicating client device 330 relates to an online session or to a group of online sessions held by that participant.

In one or more variants of the online matchmaking system 330, the communication interface 322 may receive from a communicating client device 330 of a given participant an added service request related to an online meeting, in which case the processor 324 may control delivery of the requested added service toward the communicating client device 330 of the given participant via the communication interface. Such added service requests may relate to a reveal of two-way matches for the given participant, a reveal of one-way matches for the given participant, wherein an other party to a given online meeting not resulting in a two-way match has provided favorable feedback for the given participant, a purchase of a gift for a participant to an online meeting held with the given participant, an access to a recording of an online meeting attended by the given participant, or a communication with a coach to discuss an online meeting attended by the given participant. In order to allow the possibility to charge the given participant for such added services, the database 310 may store an account for each participant and the processor 324 may debit the account of the given participant following delivery of the requested added service. In order to support some of the added services, the database 310 may store a recording of an online meeting and provide for the given participant to access the recording. The processor 324 may control delivery of the recording, via the communication interface 322, toward the communicating client device 330 of the given participant.

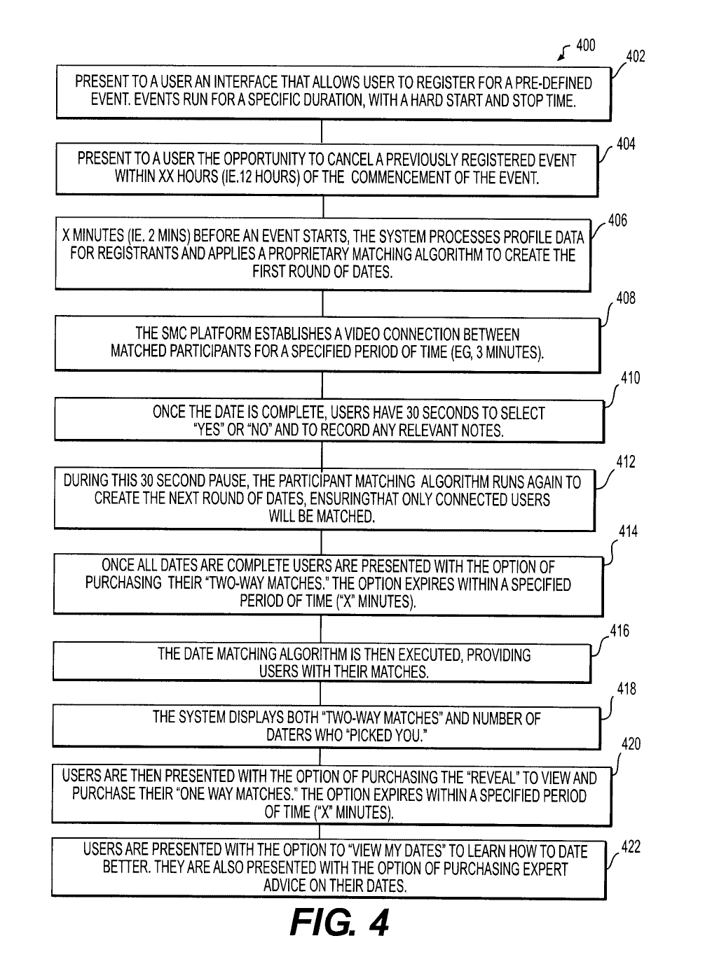

Various embodiments of the online matchmaking method and system, as disclosed herein, may be envisioned. One such embodiment may comprise a sequence diagram of FIG. 4, showing operations of an online matchmaking method according to a second embodiment. In FIG. 4, a sequence 400 comprises a plurality of operations that may be executed in variable order, some of the operations possibly being executed concurrently, some of the operations being optional. The sequence 400 includes the following operations, presented from the standpoint of a particular user, when applicable:
Operation 402: The user is presented an interface that allows the user to register for a pre-defined event. Events run for a specific duration, with a hard start and stop time.
Operation 404: The user is offered the opportunity to cancel a previously registered event within a predetermined time (i.e. 12 hours) ahead of the commencement of the event.
Operation 406: A short time (i.e. 2 minutes) before an event starts, the system processes profile data for registrants and applies a proprietary matching algorithm to create a first round of dates.
Operation 408: The system establishes a video connection between the user and a matched participant for a specified period of time (e.g. 3 minutes).
Operation 410: Once the date is complete, the user has 30 seconds to select “Yes” or “No” and to record any relevant notes.
Operation 412: During this 30 second pause, the participant matching algorithm runs again to create a next round of dates, ensuring that only users still connected to the event can be matched to the user.
Operation 414: Once all dates are complete, the user is presented with the option of purchasing “two-way matches.” The option expires within a specified period of time, lasting for a few minutes.
Operation 416: The date matching algorithm is then executed, providing the user with his/her matches.
Operation 418: The system displays both two-way matches and a number of “one-way matches, in which other daters provided favorable feedback for the user.
Operation 420: The user is then presented with the option of purchasing a “reveal”, for viewing and purchasing the one-way matches. The option expires within a specified period of time, lasting for a few minutes.
Operation 422: The user is presented with the option to view his/her dates to learn how to date better. The user is also presented with the option of purchasing expert advice on his/her dates.

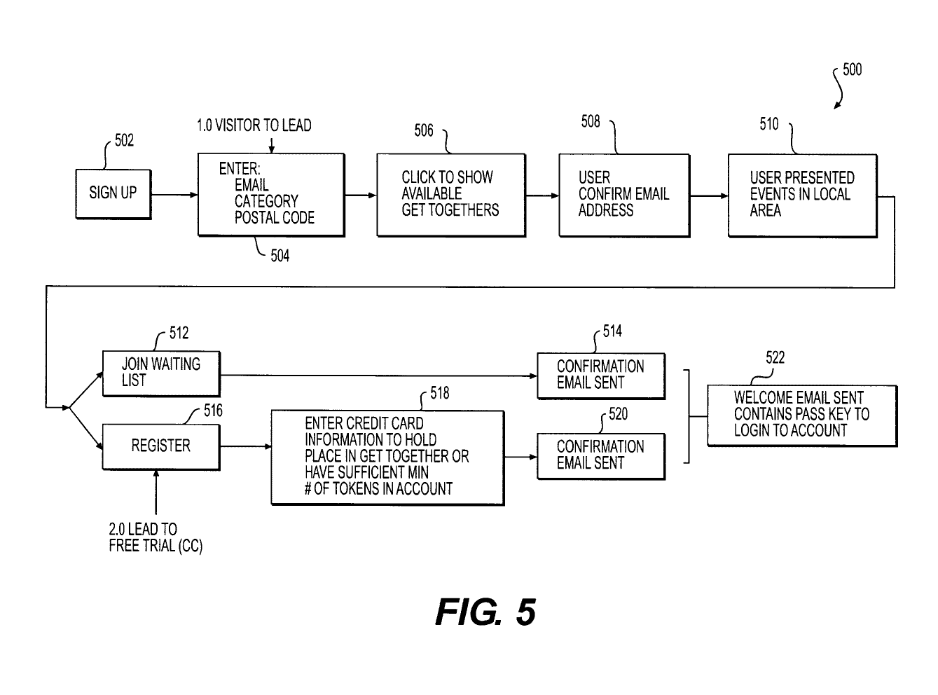

FIG. 5 is a sequence diagram showing operations of a method of registering a participant to the online matchmaking system of FIG. 3. In FIG. 5, a sequence 500 comprises a plurality of operations that may be executed in variable order, some of the operations possibly being executed concurrently, some of the operations being optional. The sequence 500 includes the following operations, presented from the standpoint of a particular user, when applicable:
Operation 502: a visitor signs in to the online matchmaking server.
Operation 504: the visitor provides initial information, such as an email address, a profile category and an indication of his/her location (e.g. a postal code or a zip code).
Operation 506: the visitor requests to see a list of upcoming matchmaking events.
Operation 508: the visitor confirms his/her email address.
Operation 510: the visitor is provided with a list of upcoming matchmaking events in proximity to his/her location.
Operation 512: the visitor opts to join a waiting list.
Operation 514: a confirmation email that the visitor is in the waiting list is sent to his/her email address.
Operation 516: the visitor opts to register into the system.
Operation 518: registration is made when the visitor provides credit card information or like financial information for requesting participation in an upcoming matchmaking event.
Operation 520: a confirmation email of that the new registered user has a place in the upcoming matchmaking event is sent to his/her email address
Operation 522: a welcome email with credentials (e.g. a password) is sent to the visitor or registered user, as applicable, so that he/she may log into the system.

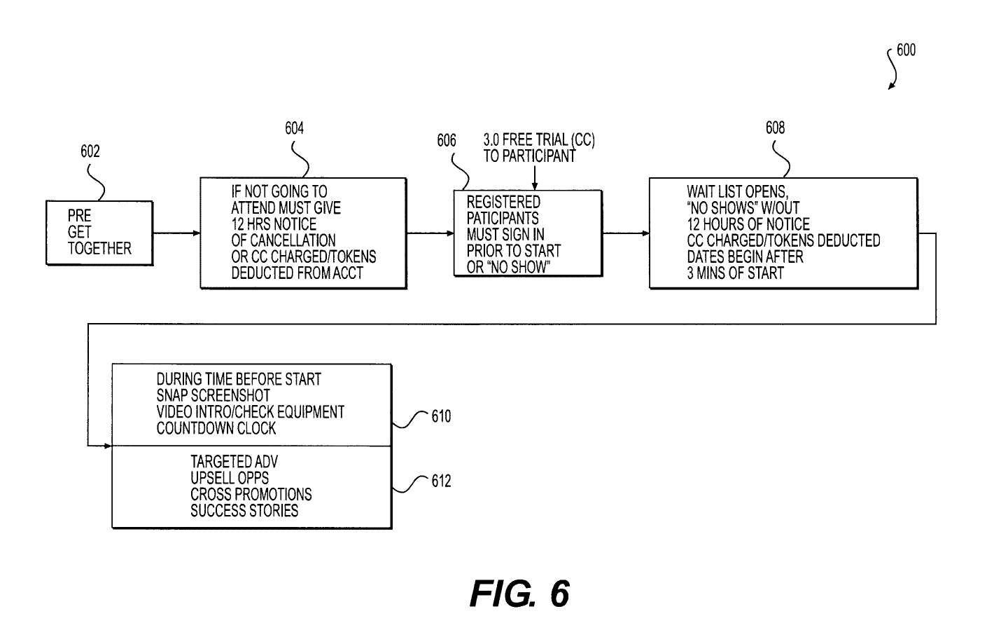

FIG. 6 is a sequence diagram showing operations that precede an online matchmaking event. In FIG. 6, a sequence 600 comprises a plurality of operations that may be executed in variable order, some of the operations possibly being executed concurrently, some of the operations being optional. The sequence 600 includes the following operations, presented from the standpoint of a particular user, when applicable:
Operation 602: the sequence leading to the start of the matchmaking event is initiated.
Operation 604: the user may indicate, before the end of a free cancellation period, that he/she will not be available to attend the matchmaking event. At the end of the free cancellation period, the list of participants is fixed.
Operation 606: the user signs in (logs into) the system to attend the matchmaking event.
Operation 608: the list of participants is adapted to remove users who failed to sign in; accounts for those missing participants are debited.
Operation 610: the user is presented with an introduction to the matchmaking event, for a brief period before a first online meeting.
Operation 612: in parallel to the introduction, targeted advertisements, offers for added services, and the like may be presented to the user.

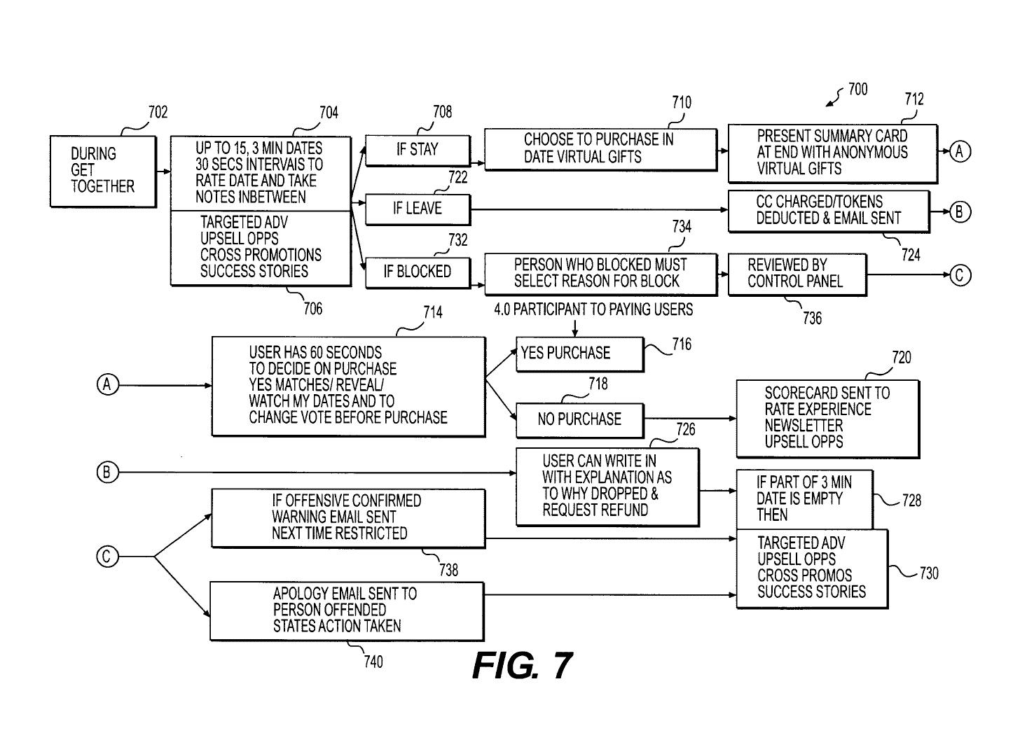

FIG. 7 is a sequence diagram showing various operation scenarios occurring in the course of the online matchmaking event. In FIG. 7, a sequence 700 comprises a plurality of operations that may be executed in variable order, some of the operations possibly being executed concurrently, some of the operations being optional. Connectors A, B and C express how the sequence 700 flows from one operation to the next and do not represent any function. The sequence 700 includes the following operations, presented from the standpoint of a particular user, when applicable:
Operation 702: the matchmaking session is initiated.
Operation 704: the user is presented with a predetermined number (e.g. 15) of online sessions, each online session lasting for 3 minutes, a 30-second interval being allotted after each online session for providing feedback and for taking notes (the number of online sessions, their duration and the duration of the interval are for illustration purposes and may vary).
Operation 706: in parallel to online sessions, targeted advertisements, offers for added services, and the like may be presented to the user
Operation 708: the user may remain signed into the system at the conclusion of his/her online sessions.
Operation 710: the user may opt to purchase a gift for delivery to an other participant met during the course of an online session. A virtual gift is a gift that can be delivered electronically to the other participant.
Operation 712: the user is present with a summary card and with anonymous gifts received from another participant.
Operation 714: the user is given a time period to decide on purchasing one or more of the added services, such as gift offerings, revealing matches, viewing date recordings, etc.
Operation 716: the user may elect to make a purchase.
Operation 718: the user may elect to not make a purchase.
Operation 720: the user may receive a scorecard for rating the matchmaking experience.
Operation 722: the user may leave the matchmaking session.
Operation 724: the user having left the matchmaking session is charged by debiting his/her account and an email is sent to his/her email address.
Operation 726: the user having left the matchmaking session can reply to the email providing an explanation why he/she left the session, possibly requesting a refund.
Operation 728: a part of an online session may be empty, a participant to a date having left the session.
Operation 730: in parallel to operation 728, targeted advertisements, offers for added services, and the like may be presented to the user.
Operation 732: the user may be blocked when another participant to an online session finds that the user's behavior is offensive.
Operation 734: the participant having blocked the user provides an indication as to why he/she blocked the user.
Operation 736: a panel reviews the reason for blocking.
Operation 738: if the user's behavior was indeed offensive, a warning email is sent to the user. A repeat offender may be blocked from the system.
Operation 740: if the user's behavior is not considered offensive by the panel, an apology email is sent to the user.

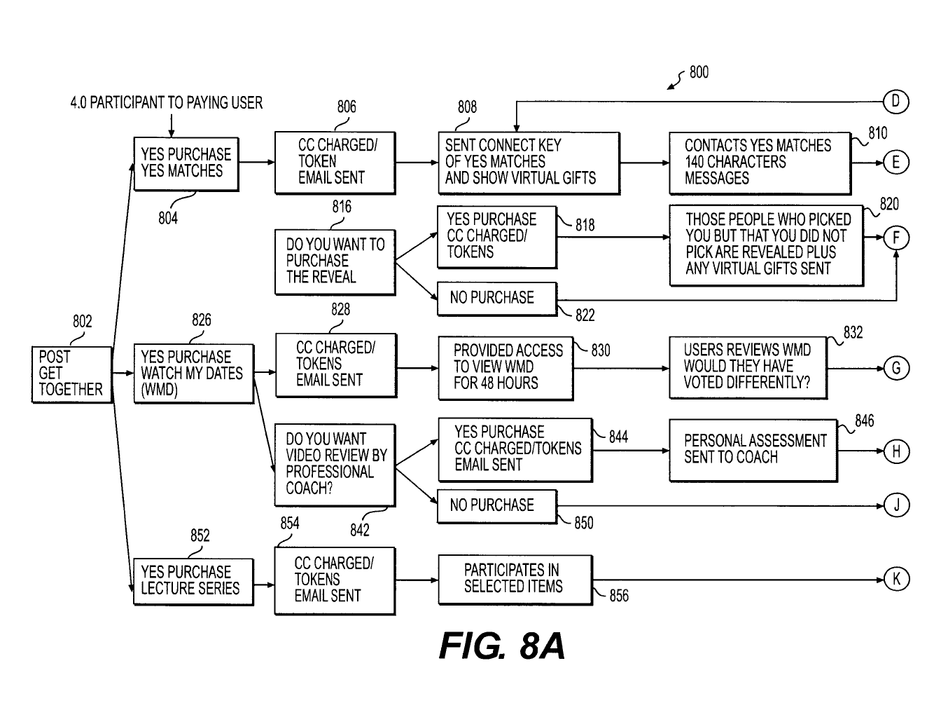

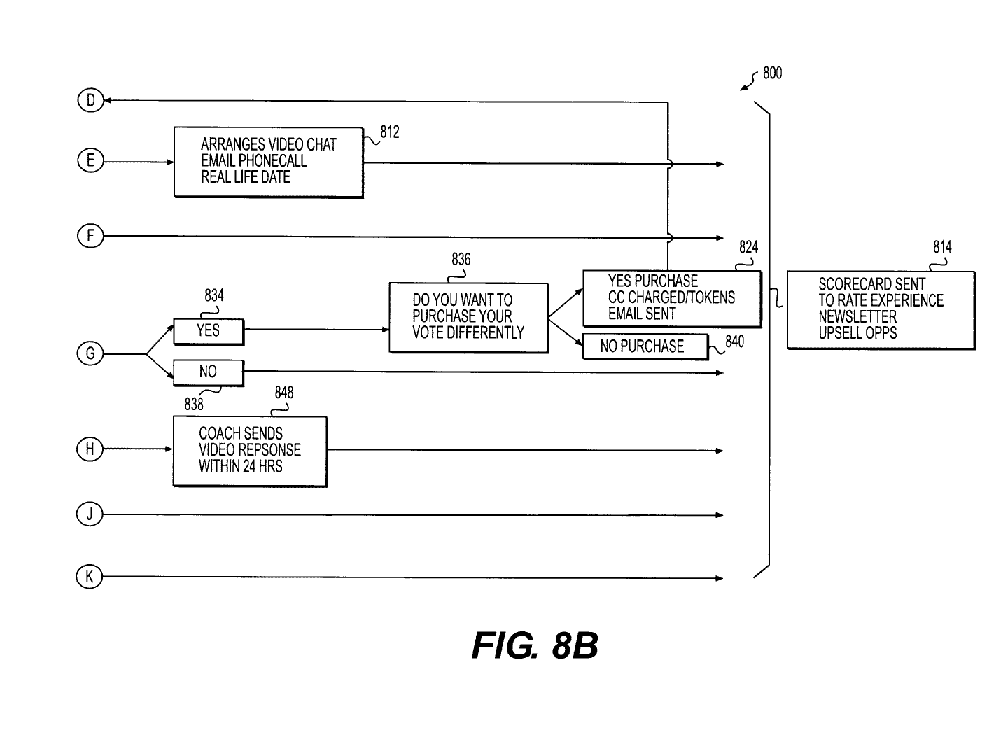

FIGS. 8a and 8b collectively are a sequence diagram showing various operation scenarios occurring after the conclusion of the online matchmaking event. In FIGS. 8a and 8b, a sequence 800 comprises a plurality of operations that may be executed in variable order, some of the operations possibly being executed concurrently, some of the operations being optional. Connectors D, E, F, G, H, J and K simply express how the sequence 800 flows from one operation to the next. The sequence 800 includes the following operations, presented from the standpoint of a particular user, when applicable:
Operation 802: the matchmaking session has ended.
Operation 804: the user purchases information about matches.
Operation 806: the user's account is debited and a confirmation email is sent to his/her email address.
Operation 808: a connect key is provided to enable establishment of a contact between the user and one of his/her matches. Possible virtual gifts are presented.
Operation 810: the user contacts a matched participant, for example by sending a 140-character message (tweet) via the system.
Operation 812: a further contact is arranged between the user and the matched participant.
Operation 814: the user fills a scorecard to provide impressions about the matchmaking experience. This operation may follow a broad range of sub-sequences within the sequence 800.
Operation 816: the user is offered the possibility of purchase a reveal of one-way matches.
Operation 818: the user's account is debited when the user accepts the offer.
Operation 820: identities of participants found in a one-way match are provided to the user. Possible gifts are presented.
Operation 822: the user may decline to purchase the reveal.
Operation 826: the user may purchase a service for reviewing recordings of his/her online meetings.
Operation 828: the user is charged for viewing his/her recordings.
Operation 830: a limited time duration is allocated for the user to view his/her recordings.
Operation 832: the user considers whether or not to change feedback provided about an other party to a recorded and viewed online meeting.
Operation 834: the user intends to change his/her feedback.
Operation 836: the user is provided with an option to change his/her feedback, for a fee.
Operation 838: the user decides not to change his/her feedback.
Operation 840: the user declines to be charged for a change of feedback.
Operation 842: the user is offered the possibility to review a recorded online meeting in the company of a coach.
Operation 844: the user purchases the coaching service and is charged for that service.
Operation 846: a personal assessment of the online meeting is sent by the user to the coach.
Operation 848: a video response from the coach is provided to the user.
Operation 850: the user may decline to purchase the coaching service.
Operation 852: the user purchases a lecture series for being better prepared for future online matchmaking events.
Operation 854: the user's account is debited.
Operation 856: the user participates in the purchased lecture series.

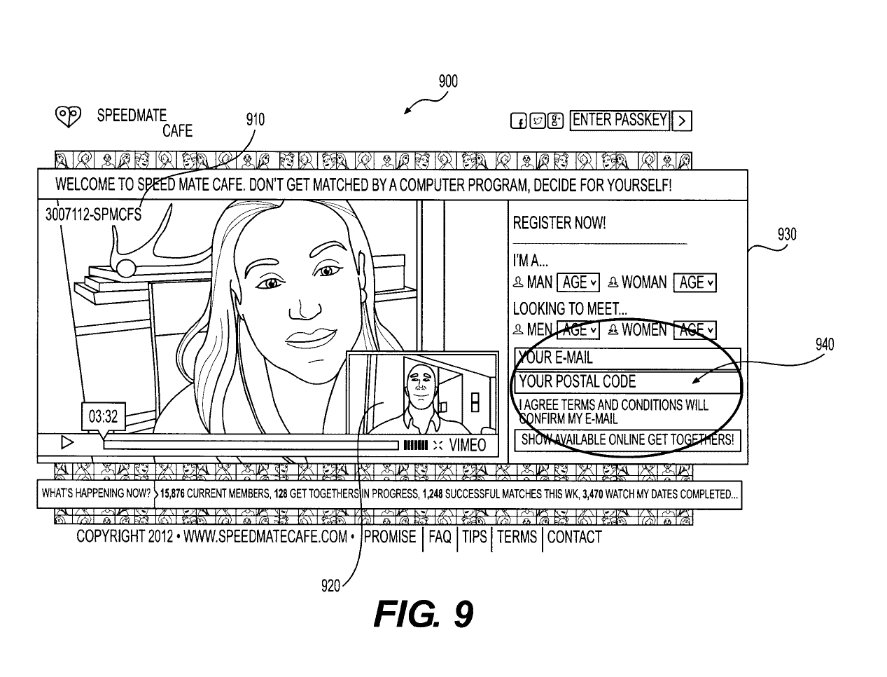

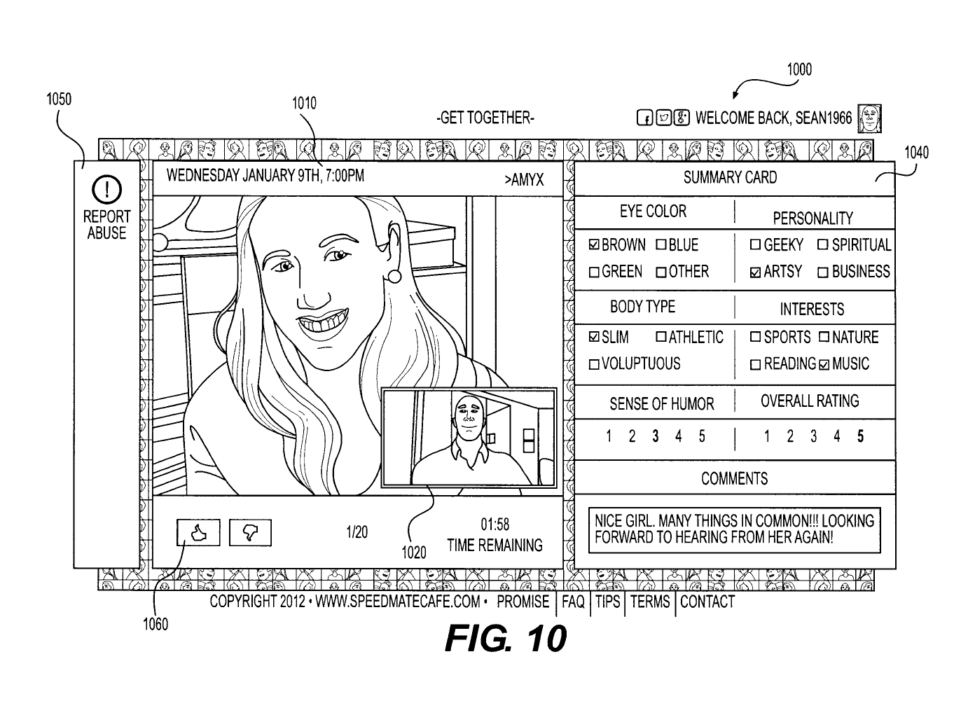

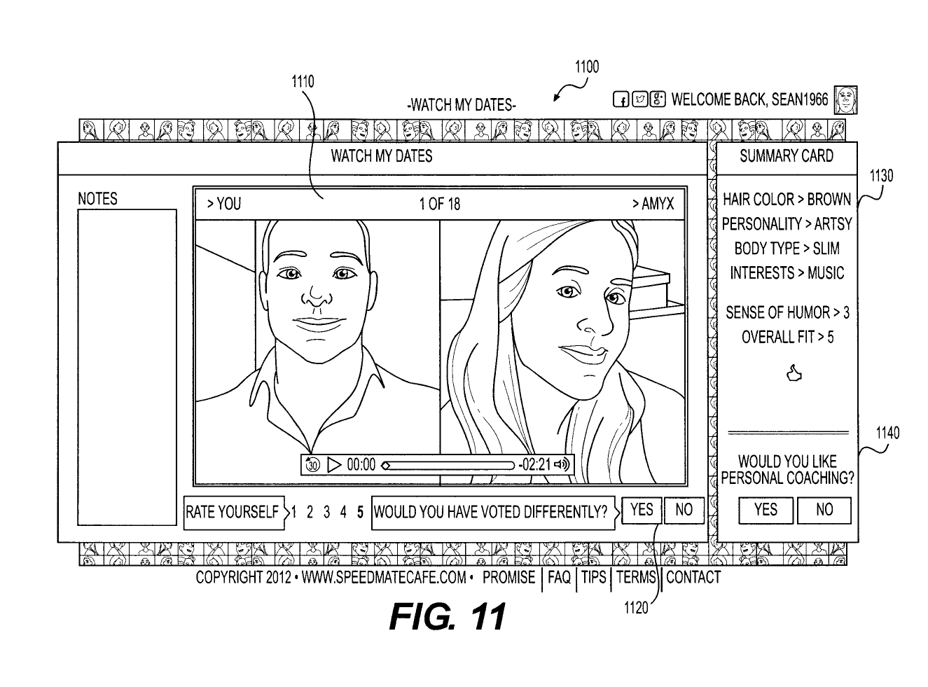

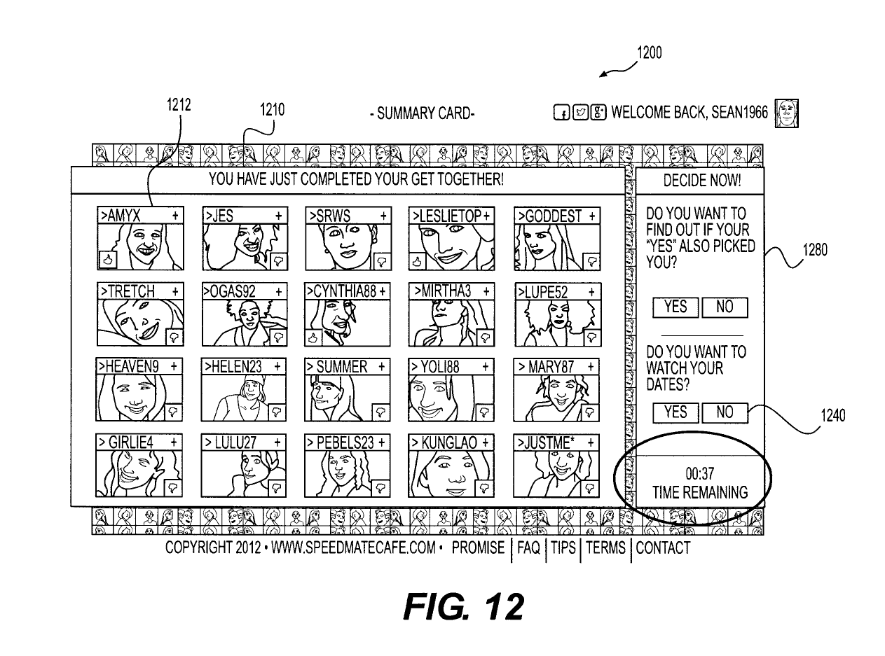

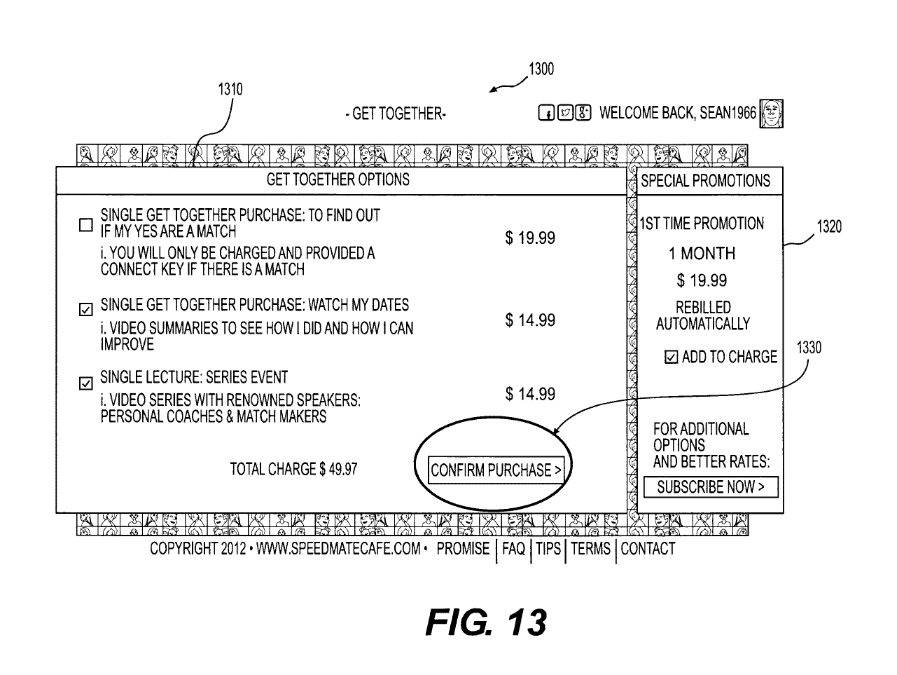

FIGS. 9 to 13 are screen captures of displays viewable on communicating client devices of participants to the online matchmaking event. Screen captures 900, 1000, 1100, 1200 and 1300 are examples of views that a user may see on a personal communication device such as a personal computer, a laptop, a mobile terminal, an intelligent terminal, a tablet, and the like. These views may be presented to the user in a web browser or in similar display systems.

The screen capture 900 is partitioned to show an image 920 of the user, an image 910 of an other party to an online session, a registration window 930 that includes fields for entering profile information, for example a location field 940 in the form of a postal code or zip code.

The screen capture 1000 shows a live image 1020 of the user, a live image 1010 of an other party to an online session, a summary card 1040 having fields for taking notes about the other party, voting buttons 1060 for providing feedback, and a field 1050 for reporting abuse when the user feels that the other party expresses incorrect behavior.

The screen capture 1100 shows a display visible by the user after the conclusion of an online session. It shows side by side images 1110 of the user and of an other party, voting buttons 1120 for modifying a previous vote, a summary card 1130, and buttons 1140 for requesting coaching service for that online session.

The screen capture 1200 shows a display visible by the user after the conclusion of the matchmaking event. It shows in a tabular form 1210 images 1212 of participants to the user's online meetings. For each image 1212, an icon 1214 shows the user's vote for the corresponding participant. The user is allowed to click on any of the icons 1214 to change his/her vote, for example changing a “thumps up” indication to a “thumbs down” indication, or vice-versa, leading to a recalculation of two-way matches. Voting buttons 1220 are provided to allow the user to purchase a list of two-way matches. Other voting buttons 1240 allow the user to access recordings of his/her dates. A clock 1230 indicates how much time remains until the options to change a vote, to access a recording, or to purchase the list of two-way matches will expire.

Finally, the screen capture 1300 provides a list 1310 of purchasable added services and a mention 1320 of special promotions. A clock 1330 indicates how much time remains until the option to purchase the services listed in the list 1301 will expire.

The screen captures 900, 1000, 1100, 1200 and 1300 further show additional fields of conventional nature. The structure and presentation of the views illustrated on FIGS. 9 to 13 may be modified for esthetic reasons, for better accommodating the size of a user's terminal, for ease of accommodating third-party software that provide for example live video feeds, or for any other reason.

Those of ordinary skill in the art will realize that the description of the online matchmaking method and system are illustrative only and are not intended to be in any way limiting. Other embodiments will readily suggest themselves to such persons with ordinary skill in the art having the benefit of the present disclosure. Furthermore, the disclosed method and system may be customized to offer valuable solutions to existing needs and problems of providing better matches and experience users of matchmaking services.

In the interest of clarity, not all of the routine features of the implementations of method and system are shown and described. It will, of course, be appreciated that in the development of any such actual implementation of the method and system, numerous implementation-specific decisions may need to be made in order to achieve the developer's specific goals, such as compliance with application-, system-, network- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of client server based services having the benefit of the present disclosure.

In accordance with the present disclosure, the components, process operations, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of operations is implemented by a computer or a machine and those operations may be stored as a series of instructions readable by the machine, they may be stored on a tangible medium.

Systems and modules described herein may comprise software, firmware, hardware, or any combination(s) of software, firmware, or hardware suitable for the purposes described herein. Software and other modules may reside on servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

Although the present disclosure has been described hereinabove by way of non-restrictive, illustrative embodiments thereof, these embodiments may be modified at will within the scope of the appended claims without departing from the spirit and nature of the present disclosure.

1. An online matchmaking method, comprising:
inviting to an online matchmaking event a plurality of participants, each participant having a participant profile;
determining, for each participant, a predetermined number of complementary participant profiles;
setting up online meetings within the online matchmaking event, each online meeting being held between participants having complementary profiles, each participant being offered to attend a number of online meetings corresponding to the predetermined number of complementary profiles;
for each given online meeting, receiving from a participant to the given online meeting a feedback related to an other participant to the given online meeting;
for each given online meeting, determining whether there is a two-way match between participants to the given online meeting based on feedback received from at least one of the participants to the given online meeting; and
informing each participant of a number of two-way matches determined from the online meetings the participant has attended in the course of the online matchmaking event.

2. The method of claim 1, comprising:
receiving from a participant a request for identifying the requesting participant's two-way matches;
providing the requesting participant with a list of the requesting participant's two-way matches; and
debiting an account of the requesting participant.

3. (canceled)

4. The method of claim 1, comprising:
receiving from a participant a request for a list of participants with whom the participant has held meetings not resulting in a two-way matches, the list of participants including other participants having provided favorable feedback for the requesting participant; and
debiting an account of the requesting participant.

5. (canceled)

6. The method of claim 1, comprising:
receiving from a participant a request to purchase a gift for a participant to an online meeting held with the requesting participant; and
debiting an account of the requesting participant.

7. (canceled)

8. (canceled)

9. (canceled)

10. The method of claim 1, comprising:
determining a first complementary participant profile for a given participant before a first online meeting for the given participant; and
determining a next complementary participant profile for the given participant before a next online meeting for the given participant.

11. (canceled)

12. The method of claim 1, wherein the online meetings are controlled by a matchmaking server in communication with communicating client devices of each participant, and wherein the matchmaking server is in communication with a cooperating server, one or more of the participants to the online matchmaking event being subscribers to the cooperating server, the cooperating server providing profile information for its subscribers to the matchmaking server.

13. (canceled)

14. (canceled)

15. (canceled)

16. The method of claim 1, comprising:
storing a subscriber list in a matchmaking server;
storing a profile for each subscriber;
presenting planning information about the online matchmaking event so that it is available to each subscriber;
receiving from a plurality of subscribers registrations for the online matchmaking event; and
adding identities of the subscribers having registered to the online matchmaking event to a list including the plurality of participants.

17. (canceled)

18. (canceled)

19. (canceled)

20. The method of claim 1, wherein the profile information comprises information about business interests of each participant, whereby the online matchmaking event is intended to lead to developing business relations.

21. The method of claim 1, wherein the profile information comprises information about personal interests of each participant, whereby the online matchmaking event is intended to lead to developing personal relations.

22. The method of claim 1, wherein the online matchmaking event is an online dating event, wherein the participant profile comprises, for each participant, an element selected from a nickname, an age, an age range for complementary profile determination, a gender, a sexual orientation, a location of residence, a range of distance from location of residence for complementary profile determination, a participant body type, a participant personality type, a participant eye color, a participant hair color, a participant's physical preferences for complementary profile determination, a participant's interests, and a combination thereof.

23. (canceled)

24. The method of claim 1, wherein the complementary participant profiles for a given participant include best complementary participant profiles.

25. The method of claim 1, wherein determining, for each participant, a predetermined number of complementary participant profiles comprises selecting at least one non-optimal complementary participant profile for a given participant.

26. (canceled)

27. (canceled)

28. (canceled)

29. (canceled)

30. (canceled)

31. (canceled)

32. (canceled)

33. An online matchmaking system, comprising:
a database storing a participant profile for each of a plurality of participants to an online matchmaking event; and
a matchmaking server having a communication interface adapted to establish connections with communicating client devices of each of the plurality of participants, the matchmaking server being operably connected to the database, the matchmaking server further comprising a processor configured to:
invite the plurality of participants to the online matchmaking event;
determine, for each participant, a predetermined number of complementary participant profiles;
set up online meetings within the online matchmaking event, each online meeting being held between participants having complementary profiles, each participant being offered to attend a number of online meetings corresponding to the predetermined number of complementary profiles;
for each given online meeting, receive from a participant to the given online meeting a feedback related to an other participant to the given online meeting;
for each given online meeting, determine whether there is a two-way match between participants to the given online meeting based on feedback received from at least one of the participants to the given online meeting; and
inform each participant of a number of two-way matches determined from the online meetings the participant has attended in the course of the online matchmaking event.

34. The system of claim 33, wherein:
the communication interface is configured to receive from a communicating client device of a given participant an added service request related to an online meeting; and
the processor is configured to control delivery of the requested added service toward the communicating client device of the given participant via the communication interface;
wherein the requested added service is selected from:
a reveal of two-way matches for the given participant;
a reveal of one-way matches for the given participant, wherein an other party to a given online meeting not resulting in a two-way match has provided favorable feedback for the given participant;
a purchase of a gift for a participant to an online meeting held with the given participant;
an access to a recording of an online meeting attended by the given participant; and
a communication with a coach to discuss an online meeting attended by the given participant.

35. (canceled)

36. The system of claim 34, wherein:
the database is configured to store an account for each participant; and
the processor is configured to debit the account of the given participant following delivery of the requested added service.

37. The system of claim 34, wherein:
the database is configured to store a recording of an online meeting;
the added service request is a request to access the recording; and
the processor is configured to control delivery of the recording, via the communication interface, toward the communicating client device of the given participant.

38. The system of claim 34, wherein:
the database stores a user identity and a password for each participant; and
the processor configured to verify the user identity and the password of a given participant when the communication interface receives an access to the system from a communicating client device of the given participant.

39. The system of claim 34, wherein the matchmaking server is a web server and the communication interface is configured to connect with communicating client devices via the Internet.

40. The system of claim 34, wherein the communication interface is further configured to connect with a cooperating server and to receive therefrom at least one of the participant profiles.

41. (canceled)

42. A system for enabling online matchmaking, comprising a matchmaking server, the matchmaking server including:
a computer processor;
a database operationally connected with the computer processor and storing profiles of possible participants of an online matchmaking event;
a communication interface operationally connected with the computer processor and structured and configured to communicate with communication client devices of at least one of the possible participants; and
a non-transient computer information storage device operationally connected with the computer processor, the information storage device containing program instructions that, when executed by the computer processor, effect:
scheduling the online matchmaking event;
receiving registrations to the online matchmaking event from a plurality of participants;
accessing the database to obtain profiles for each of the plurality of the participants;
processing rules for matching subsets of the plurality of participants based on complementary interests within their profiles;
initiating and controlling online meetings between the subsets;
registering feedback from the plurality of participants;
identifying matches among the subsets based on the registered feedback; and
providing at least one additional value added service for a fee.
